(19) United States
(12) Patent Application Publication
(10) Pub. No.: US 2006/0031153 A1
(43) Pub. Date: Feb. 9, 2006

(54) Methods and systems for matching buyers and sellers over electronic networks

(76) Inventor: Mike Insang Kim, Rancho Santa Margarita, CA (US)

Correspondence Address: STETINA BRUNDA GARRED & BRUCKER, 75 ENTERPRISE, SUITE 250, ALISO VIEJO, CA, 92656, US

(21) Appl. No.: 10/911,799

(22) Filed: Aug. 5, 2004

(51) Int. Cl. G06Q 40/00

(52) U.S. Cl. 705/37

(57) ABSTRACT

An electronic matching system is provided for facilitating online transactions between buyers and sellers. Electronic buy offers and electronic sell offers received by the system can be compared and matched. The offers can be transmitted to the system through a plurality of communication media including email messaging, text messaging, and/or postings made to web sites. If matching offers are detected by the system, then the existence of the match can be communicated to a buyer/seller according to message forwarding preferences of the buyer/seller. The online status of an email computing device associated with the buyer/seller can be detected. Email messages generated by the system can be converted into text message format and received by a mobile computing device associated with the buyer/seller if the email computing device is offline.

### CROSS-REFERENCE TO RELATED APPLICATIONS

Not applicable

### STATEMENT RE: FEDERALLY SPONSORED RESEARCH/DEVELOPMENT

Not Applicable

### FIELD OF THE INVENTION

The present invention relates generally to technology for facilitating online transactions, and more particularly to methods and systems for matching buyers with sellers using different communication media.

### BACKGROUND OF THE INVENTION

The proliferation of online communication tools in recent years has allowed businesses and the consuming public to transact a growing amount of business online. As a result, it is often necessary for persons to utilize more than one form of communication media when engaging in business.

Unfortunately, the large number of available communication tools can present great difficulty to persons seeking to conduct business. For example, although email can provide a convenient, quick way to communicate offers to buy or sell goods or services, the buyer or seller making the offer may not be present at an appropriate email computing device to view any further email messages received in connection with the proposed transaction. Even if email messages are queued for later viewing, such functionality does not allow the buyer/seller to view such messages until physically returning to an appropriate email computing device.

Text messaging functionality offered by various wireless mobile devices can facilitate the receipt of electronic messages in text message format. Nevertheless, buyers/sellers who use such mobile devices often do not know whether electronic messages pertaining to an outstanding offer to buy or sell will be transmitted to the mobile device, or whether the buyer/seller must continue to check for email messages on a separate email computing device. Such realities can force businesspersons to limit their electronic message communications to only a single form of communication media in order to ensure that other relevant messages are viewed in a timely fashion.

Accordingly, there exists a need for a comprehensive system which provides a streamlined approach to conducting online transactions. It would be desirable for such a system to allow buyers and sellers to transmit offers electronically, and receive notifications of matching offers while away from an email computing device.

### BRIEF SUMMARY OF THE INVENTION

The present invention, roughly described, is directed to methods and systems for matching buyers and sellers, and for communicating the match result to the buyer/seller over a plurality of communication media.

In various embodiments, an electronic buy offer and an electronic sell offer can be received by a system server. The offers can be compared to obtain a match result, and message forwarding preferences of the buyer and/or seller can be accessed. The online status of an email computing device associated with the buyer/seller can be detected. Data packets generated by a software program running on the email computing device can be periodically sent to the system server in order to inform the server that the email computing device is currently online. If a data packet is not received by the system server within a preselected time period, the system server can determine that the email computing device is no longer online.

Upon a comparison of the detected online status with the message forwarding preferences, the match result can be communicated to the email computing device or a mobile computing device associated with the buyer/seller. An email message identifying the match result can be converted into text message format and forwarded to the mobile computing device of the buyer/seller while the email computing device is offline.

In certain embodiments, the message forwarding preferences of the buyer/seller can specify various criteria to be met in order for an email message generated by the system to be converted to text message format and forwarded to the mobile computing device. Such criteria can include, but need not be limited to: particular sending parties, time, date, whether the receiving party is logged in to a web site, and/or other criteria.

These and other embodiments of the present invention are discussed in further detail below.

### BRIEF DESCRIPTION OF THE DRAWINGS

FIG. 1 is a block diagram illustrating an electronic matching system in accordance with an embodiment of the present invention.

FIG. 2 is a flowchart describing a process for informing a system server of an online status of an email computing device in accordance with an embodiment of the present invention.

FIG. 3 is a flowchart describing a process for detecting an online status of an email computing device in accordance with an embodiment of the present invention.

FIG. 4 is a flowchart describing a process for receiving and matching offers in accordance with an embodiment of the present invention.

FIG. 5 is a flowchart describing a process for informing buyers and sellers of matching offers in accordance with an embodiment of the present invention.

FIG. 6 is a flowchart describing a process for buyer/seller interaction with an electronic matching system in accordance with an embodiment of the present invention.

### DETAILED DESCRIPTION OF THE INVENTION

An electronic matching system in accordance with the present invention can provide functionality for matching buyers with sellers over a plurality of communication media, thereby facilitating electronic transactions. In various embodiments, buyers and sellers can transmit offers to the system using various communication media, such as web site postings, email messages, or text messages. The system can inform buyers and sellers of matching offers through various communication media, depending on the message forwarding preferences of the buyers and sellers.

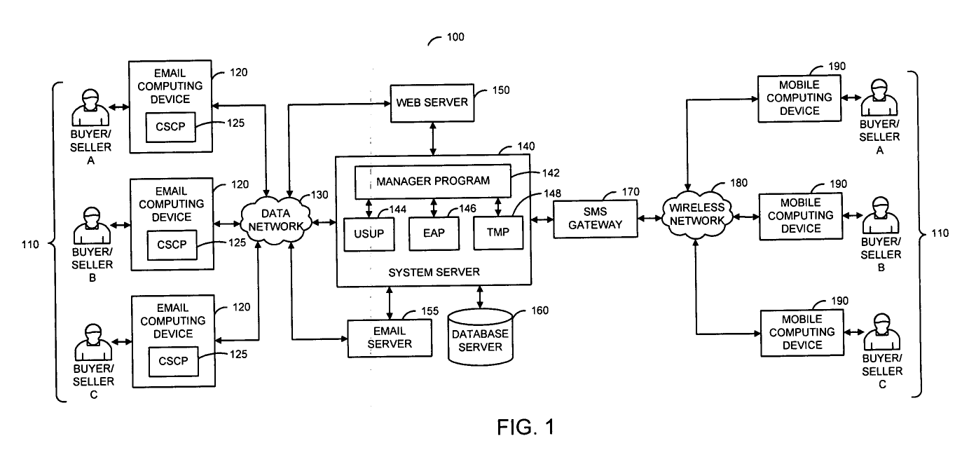

FIG. 1 is a block diagram illustrating an electronic matching system 100 in accordance with an embodiment of the present invention. Using system 100, a plurality of buyers and sellers 110 can interact with each other through various email computing devices 120 and mobile computing devices 190. As further described herein, email and text messages can be received by buyers/sellers 110 through their associated email computing devices 120 and mobile computing devices 190 in accordance with message forwarding preferences of the buyers/sellers 110.

As illustrated in FIG. 1, each buyer/seller 110 of system 100 can have an associated email computing device 120 and mobile computing device 190. Email computing devices 120 can be any computing devices known in the art capable of sending, receiving, and/or displaying email messages to a buyer/seller 110. In various embodiments, computing devices 120 can be conventional personal computers, laptop computers, workstations, terminals, and/or any other type of computing device known in the art. Mobile computing devices 190 can be any appropriate mobile computing devices known in the art capable of sending and/or receiving text messages over a wireless network 180, and displaying such text messages to a buyer/seller 110. It will be appreciated that mobile computing devices 190 can be mobile phones, personal digital assistants, and/or any other type of computing device known in the art. Although computing devices 120 and mobile devices 190 are described more fully herein in relation to email and text messages, respectively, it will be appreciated that support for other types of electronic messages is also contemplated by the present invention.

The message forwarding system 100 can advantageously detect whether an email computing device 120 associated with a particular buyer/seller 110 is online. If the associated email computing device 120 is online, then email messages intended for the buyer/seller can be routed to the buyer/seller's email address, and text messages intended for the buyer/seller can be converted into email messages for routing to the buyer/seller's email address. However, if the email computing device 120 is offline, then text messages intended for the buyer/seller can be routed to the buyer/seller's mobile computing device 190, and email messages intended for the buyer/seller can be converted into text messages which are forwarded to the buyer/seller's mobile computing device 190. As a result, buyers/sellers using system 100 can be informed by system 100 of matching offers by way of text messages while away from an email computing device 120, or by way of email messages while at the email computing device 120.

Each of email computing devices 120 can communicate with a data network 130 which facilitates communication between various components of system 100. For example, email messages sent from email computing devices 120 over network 130 can be received by an email server 155 for further processing by system 100. Network 130 can be any of the various networks known in the art to facilitate data transmission, including but not limited to the Internet, a wide area network (WAN), a virtual private network (VPN), a wireless network, and/or others known in the art.

System 100 can optionally provide a web site through a web server 150 permitting buyers/sellers 110 to login and/or register with the system 100 by providing registration information through the web site. Buyers/sellers 110 who are registered members of the system 100 can be permitted to enter their message forwarding preferences through the web site, as further described herein. In addition, web server 150 can also provide a web site for facilitating online transactions. Offers to buy or sell items can be posted to the web site by buyers/sellers 110. Such offers can be communicated from the web server 150 to system server 140 for further processing, as further described herein.

A system server 140 provides the message routing, conversion, and offer matching functionality of system 100. As illustrated, system server 140 is in communication with a web server 150, email server 155, database server 160, SMS gateway 170, and network 130. Various software applications 142, 144, 146, and 148 can be provided on system server 140 for instructing the server 140 to perform specific functionality described more fully herein. Message forwarding preferences of buyers/sellers 110 can be stored in database server 160 which is in communication with system server 140. Such message forwarding preferences can include preferences Selected by buyers/sellers 110 pertaining to the manner and conditions under—which electronic email and/or text messages will be converted and/or forwarded by system server 140 to the email computing devices 120 and/or mobile computing devices 190 of buyers/sellers 110. For example, such conditions can include but need not be limited to: the message sender, time, date, on/off/idle status of a buyer/seller's 110 email computing device 120, and/or other conditions.

Email server 155 is in communication with network 130 and system server 140 for receiving email messages sent by one or more email computing devices 120 and passing such email messages to system server 140. Database server 160 is in communication with system server 140 for storing message forwarding preferences of buyers/sellers 110.

SMS gateway 170 is in communication with system server 140 and a wireless network 180, thereby facilitating communication between system server 140 and the wireless network 180. Wireless network 180 can be any appropriate network that facilitates wireless communication to and from mobile computing devices 190, such as GSM/PCS digital cellular network or others known in the art.

Each of mobile computing devices 190 can communicate with wireless network 180 for exchanging text messages with other components of the system 100. For example, text messages sent from mobile computing devices 190 over network 180 can be received by SMS gateway 170 for further processing by system 100.

A client status checking program (“CSCP”) 125 is provided on each email computing device 120. As further described herein, CSCP 125 operates to send information to system server 140 while the email computing device 120 is online. When a buyer/seller 110 turns on an email computing device 120, CSCP 125 can be executed automatically and loaded into the memory of the email computing device 120. In various embodiments, CSCP 125 can generate data packets which contain a buyer/seller's settings, name, and login status. Such packets are sent through network 130 to system server 140.

Turning now to the software applications running on system server 140, it will be appreciated by those skilled in the art that discreet software applications 142, 144, 146, and 148 are illustrated as running on system server 140. However, any appropriate arrangement of software components can be employed to provide the functionality of system server 140 described herein. It will also be appreciated that although database server 1-60 is illustrated as separate from system server 140, the storage of buyer/seller message forwarding preferences can be provided in accordance with any storage technology known in the art, including but not limited to one or more separate databases.

A user status update program (“USUP”) 144 is provided on system server 140 for receiving and analyzing data packets transmitted by the various CSCP 125 programs running on email computing devices 120. USUP 144 waits to receive a data packet from CSCP 125 within a predetermined time interval. If no data packet is received within the time interval, then the USUP 144 determines that the email computing device 120 is offline. If a data packet is received, then USUP 144 determines that the email computing device 120 is online. The USUP 144 then decodes the data packet and updates the online status associated with the email computing device 120 running the CSCP 125. USUP 144 can also be provided with functionality for updating buyer/seller settings extracted from such data packets and updating those settings in database server 160. In various embodiments, USUP can be implemented as a software program written in ASP, VC++, and VB programming languages.

A manager program 142 is also provided on system server 140 for managing the matching of offers and the selective forwarding of electronic messages in accordance with the present invention. Manager program 142 receives data from USUP 144 as to which email computing devices 120 are online. In response to a detected online status, manager program 142 can selectively convert electronic messages received in email format into text message format, and vice versa. The converted messages can then be forwarded to an email computing device 120 and/or mobile computing device 190 as desired. For example, in the event that the manager program 142 successfully matches a buy offer with a sell offer, an email message can be generated for informing the buyer and/or seller of the match. The email message can be converted into text message format and forwarded to the buyer/seller in response to a detected online status of the email computing device 120 of the buyer/seller.

An email analyze program (“EAP”) 146 is further provided on system server 140 for analyzing email messages received from email server 155. In various embodiments, EAP 146 can analyze the header of such email messages and identify the sending and receiving parties. If both parties are authorized users of system 100, or have software sufficient to interact with system server 140, then such email messages will be passed to manager program 142.

A text messaging-program (“TMP”) 148 is also provided on system server 140 for sending and receiving text messages between system server 140 and SMS gateway 170.

CSCP 125 can be implemented as a client side software program written in VC++ and VB programming languages. In various embodiments, CSCP 125 is preinstalled into each of computing devices 120 before such devices can interact with system 100.

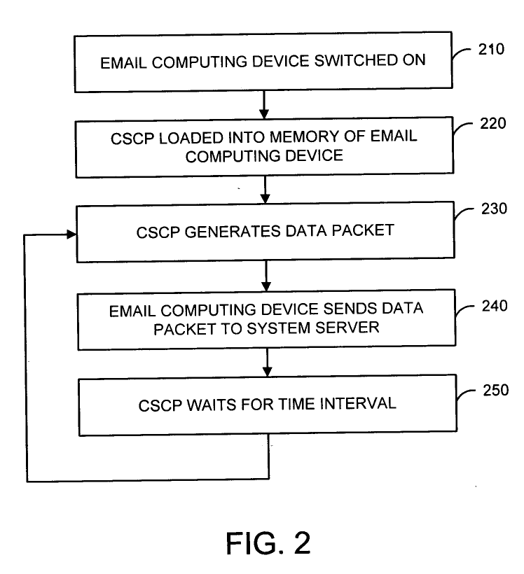

FIG. 2 is a flowchart describing a process for informing system server 140 of an online status of an email computing device 120 in accordance with an embodiment of the present invention.

In initial step 210, an email computing device 120 is switched on and begins its boot up cycle. Typically, step 210 will be performed in response to a buyer/seller's 110 decision to switch on the email computing device 120. During the boot up cycle, CSCP 125 is loaded into the memory of device 120 and begins running (step 220).

While the CSCP 125 is running, it periodically generates a data packet (step 230) to be sent by the email computing device 120. The data packet sent in step 230 can comprise any desired collection of data desirable to be sent to system server 140. For example, the data packet could identify the buyer/seller's 110 name, message forwarding preferences, login status, and/or other information.

In step 240, the data packet is sent by the email computing device to system server 140 over network 130. After the data packet is sent, the CSCP 125 waits for a preselected time interval (step 250) before returning to step 230 and generating the next data packet. In various embodiments, the time interval identified in step 250 can be set by the buyer/seller 110 as part of the buyer/seller's 110 message forwarding preferences.

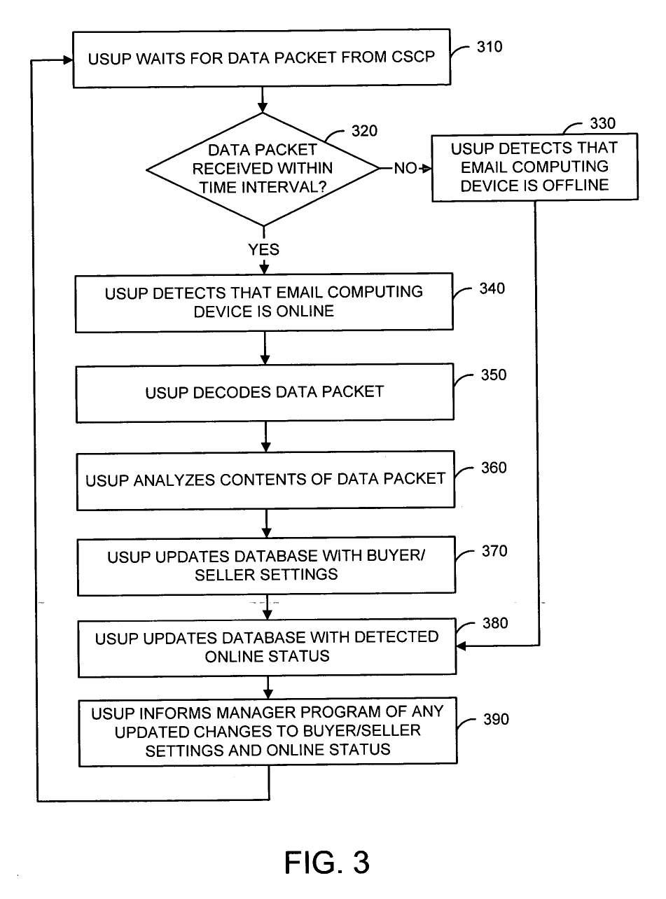

It will be appreciated that steps 230, 240, and 250 collectively identify an iterative process during which data packets are periodically sent from the email computing device 120 to system server 140. However, the iterative process can be interrupted if CSCP 125 stops functioning and/or if the email computing device 120 is switched off. CSCP 125 can also be implemented to perform the iterative process only while a buyer/seller 110 is logged in to the email computing device 120 and/or is logged in to a web site provided by web server 150. Similarly, if communications between email computing device 120 and network 130 are interrupted, then data packets sent by the email computing device 120 will not be received by system server 140. As further described herein in relation to FIG. 3, the interruption of this iterative process can facilitate the detection by system server 140 of whether the email computing device 120 is online.

FIG. 3 is a flowchart describing a process for detecting an online status of an email computing device 120 in accordance with an embodiment of the present invention. The process of FIG. 3 can be performed by the USUP 144 software running on system server 140.

At step 310, USUP 144 waits to receive a data packet from the CSCP 125 program running on an email computing device 120. If no data packet is received within a predetermined time interval (step 320), then USUP 144 detects that the email computing device 120 is offline (step 330), and the process of FIG. 3 proceeds to step 380.

If, however, a data packet is received by USUP 144 (step 320), then USUP 144 detects that the email computing device 120 is online (step 340). USUP 144 then decodes the data packet (step 350) and analyzes the contents (step 360). USUP 144 updates database server 160 with any buyer/seller settings contained in the data packet, such as message forwarding preferences of the buyer/seller (step 370).

At step 380, USUP 144 updates the database server 160 with the online status detected in step 330 (if no data packet was received) or step 340 (if a data packet was received). USUP 144 informs the manager program 142 of any changes to the buyer/seller's 110 settings and online status of the buyer/seller's 110 email computing device 120. The process then returns to step 310 where USUP 144 waits for the next data packet to arrive.

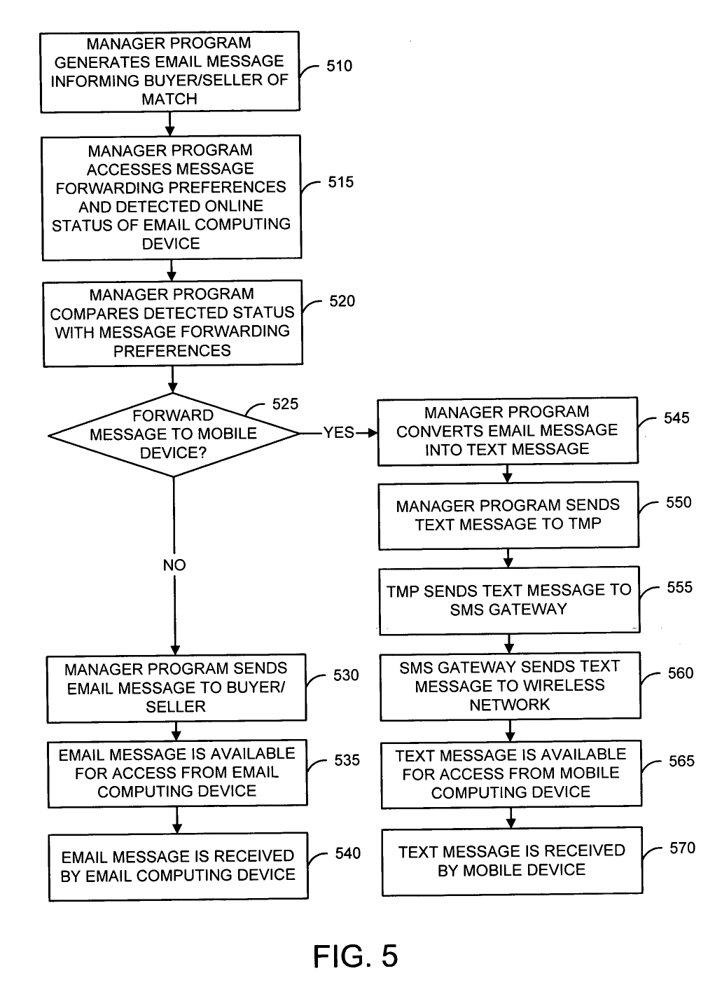

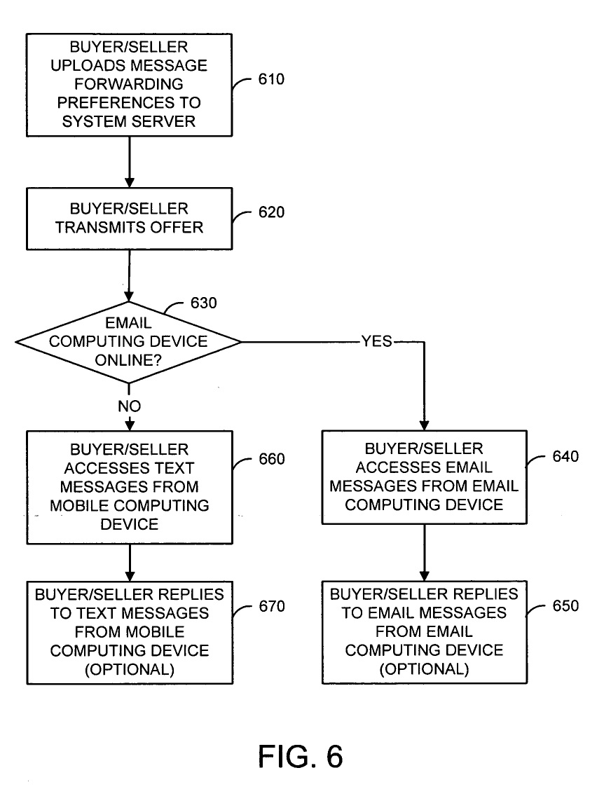

It will be appreciated that process of FIG. 3 provides system server 140 with an online status associated with a given email computing device 120 (i.e. whether the email computing device 120 is online or offline). As explained in relation to FIGS. 5 and 6 below, this online status can be used by software running on system server 140 to take appropriate action in converting and/or forwarding electronic messages to appropriate computing devices for buyers/sellers 110 of system 100.

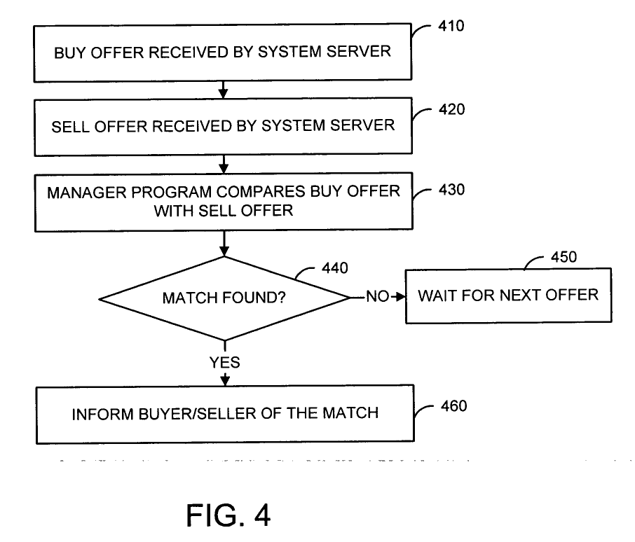

FIG. 4 is a flowchart describing a process for receiving and matching offers in accordance with an embodiment of the present invention.

At step 410, system server 140 receives a buy offer from one of the buyers/sellers 110 of system 100. In step 420, the system server 140 receives a sell offer from one of the buyers/sellers 110. It will be appreciated that the buy offer need not be received prior to the sell offer. It is contemplated that the offers can be received by system server 140 in any order, or simultaneously. It is further contemplated that the offers received in steps 410 and 420 can be received by system server 140 in accordance with any communication method known in the art. For example, one or more of the offers could be received as an email message transmitted from an email computing device 120, a text message transmitted from a mobile computing device 190, and/or a posting to a web site provided by web server 150.

At step 430, the manager program 142 compares the buy offer with the sell offer to obtain a match result. If the match result indicates that the buy and sell offers sufficiently match each other (step 440), then the buyer and seller associated with the offers are informed of the match (step 460). If no match is found, then the system server 140 waits to receive the next offer.

FIG. 5 is a flowchart describing a process for informing buyers and sellers of matching offers in accordance with an embodiment of the present invention. It will be appreciated that the process of FIG. 5 can be performed at step 460 of FIG. 4. It will further be appreciated that the process of FIG. 5 can be separately performed for the buyer and seller, thereby informing each of the buyer and seller of the match found in step 440 of FIG. 4.

At step 510, the manager program 142 generates an email message informing the buyer/seller of the match. Manager program 142 then accesses the message forwarding preferences of the buyer/seller, and further accesses the detected online status of the email computing device 120 associated with the buyer/seller (step 515). In one embodiment, the information accessed in step 515 is obtained from database server 160. In another embodiment, such information is obtained from USUP 144.

At step 520, manager program 142 compares the detected online status (accessed in step 515) with the message forwarding preferences (also accessed in step 515) to obtain a comparison result. In response to the comparison result, manager program 142 determines whether the email message should be forwarded to a mobile device 190 associated with the buyer/seller (step 525).

For example, if the buyer/seller's message forwarding preferences indicate that email messages should be forwarded to the buyer/seller's mobile device 190 when the buyer/seller's email computing device 120 is offline, then the process of FIG. 5 will proceed to step 545 if the online status (detected in FIG. 3) indicates that the email computing device 120 is offline. Otherwise, the process proceeds to step 530 where the email message is sent to the email address of the buyer/seller. The email message is made available for access from the email computing device 120 of the buyer/seller (step 535) and can be received by the email computing device 120 when the buyer/seller checks the email computing device 120 for email messages (step 540).

At step 545, manager program 142 converts the email message into a text message suitable for transmission to a mobile computing device 190. The manager program 142 then sends the newly converted text message to TMP 148 (step 550) which proceeds to send the text message to SMS gateway 170 (step 555). Upon receiving the text message, the SMS gateway sends the text message to wireless network 180 (step 560) where it is available for access from the buyer/seller's mobile device 190 (step 565). The converted text message will then be received by the mobile device 190 (step 570) when the buyer/seller checks the mobile device 190 for text messages.

In addition to the particular embodiment set forth in the discussion of FIG. 5 above, it will be appreciated that system 100 can also be implemented to always make email messages available for access from the buyer/seller's associated email computing device 120 and/or mobile computing device 190, regardless of whether the messages are also forwarded to another computing device associated with the buyer/seller.

FIG. 6 is a flowchart describing a process for buyer/seller interaction with an electronic matching system 100 in accordance with an embodiment of the present invention. It will be appreciated that the steps of FIG. 6 illustrate the perspective of a typical user of system 100, such as a buyer or seller 110 having an associated email computing device 120 and mobile computing device 190.

At initial step 610, the buyer/seller uploads the buyer/seller's desired message forwarding preferences to system server 140. It will be appreciated that step 610 can be performed by the buyer/seller inputting the message forwarding preferences into a web page provided by web server 150, or through any of the various ways known in the art for providing data to a server. In response, system server 140 stores the preferences on database server 160. Thereafter, system 100 will forward and/or convert email messages and text messages directed toward the buyer/seller in accordance with the stored message forwarding preferences.

At step 620, the buyer/seller transmits a buy or sell offer to the system 100. As previously described herein, such offers can be transmitted as email messages, text messages, and/or web site postings. If a matching offer is found by system 100, then the system 100 can inform the buyer/seller of the matching offer by way of an email message and/or text message in accordance with the process of FIG. 5.

If the buyer/seller's email computing device 120 is online (step 630), then the buyer/seller can access email messages (including text messages converted into email messages) from the buyer/seller's email computing device 120 (step 640). The buyer/seller can optionally reply to the email messages (step 650) from the email computing device 120. In contrast, if the buyer/seller's email computing device 120 is offline (step 630), then the buyer/seller can access text messages (including email messages converted into text messages) from the buyer/seller's mobile computing device 190 (step 660). The buyer/seller can optionally reply to the text messages (step 670) from the mobile computing device 190.

It will be appreciated that if the buyer/seller chooses to send an email message (step 650) or text message (step 670) to another buyer/seller of system 100, then such messages can be processed by system 100 in accordance with the message forwarding preferences of the second buyer/seller. Thus, by setting the message forwarding preferences as desired, any of the buyers/sellers of system 100 can receive email and text message notifications of matching offers to buy or sell, as well as messages from other buyers/sellers, regardless of whether the buyers/sellers are physically present at an email computing device 120.

It will be appreciated that the scope of the present invention is not limited by the particular embodiments set forth herein. Other appropriate variations, whether explicitly provided for or implied, are contemplated by the present disclosure. The ordering of various steps described herein can be changed where appropriate to achieve the functionality provided by the present invention. Similarly, individual steps can be combined and/or dissected into fewer or greater numbers of steps where appropriate to provide the functionality described herein.

What is claimed is:

1. A method for electronically matching a buyer with a seller over a plurality of communication media, the buyer and seller each having message forwarding preferences and a first associated computing device, the method comprising:
receiving an electronic buy offer from the buyer;
receiving an electronic sell offer from the seller;
comparing the buy and sell offers to obtain a match result;
accessing the message forwarding preferences of at least one of the buyer and seller;
detecting an online status of the first computing device of the at least one of the buyer and seller;
comparing the detected online status with the message forwarding preferences of the at least one of the buyer and seller to obtain a comparison result; and
communicating the match result to the at least one of the buyer and seller through communication media determined by the comparison result.

2. The method of claim 1, the communicating step comprising:
sending an email message to the first computing device of the at least one of the buyer and seller if the detected online status indicates the first computing device is online, the email message identifying the match result.

3. The method of claim 1, the communicating step comprising:
sending a text message to a second computing device of the at least one of the buyer and seller if the detected online status indicates the first computing device is offline, the text message identifying the match result.

4. The method of claim 3, the first computing device is an email computing device, the second computing device is a mobile computing device.

5. The method of claim 4, the mobile computing device is a mobile phone.

6. The method of claim 4, the email computing device is a personal computer.

7. The method of claim 1, the message forwarding preferences comprising information selected from the group consisting of:
a set of users;
a time;
a date; and
a user login status.

8. The method of claim 1, the detecting step comprising:
receiving a data packet from the first computing device; and
storing the online status in response to receiving the data packet.

9. The method of claim 1, the method is performed by software running on a system server.

10. A method for conducting an electronic transaction between a buyer and a seller over a plurality of communication media, at least one of the buyer and seller having: (i) message forwarding preferences, (ii) a first associated computing device, and (iii) a second associated computing device, the method comprising:
transmitting a first message identifying a first offer, the first message is transmitted over a first electronic network by the first computing device to a server, the electronic network employing a first communication media; and
receiving a second message identifying a second offer matching the first offer, the second message is received over a second electronic network by the second computing device if the first computing device is offline, the second electronic network employing a second communication media.

11. The method of claim 10, the first computing device is an email computing device, the first message is an email message, the second computing device is a mobile computing device, the second message is a text message.

12. The method of claim 11, the mobile computing device is a mobile phone.

13. The method of claim 11, the email computing device is a personal computer.

14. The method of claim 10, the first network is the Internet, the second network is a wireless network.

15. The method of claim 14, the server is a web server providing a web site for facilitating online transactions.

16. The method of claim 15, the first message is a posting to the web site.

17. A system for electronically matching a buyer with a seller over a plurality of communication media, the buyer and seller each having message forwarding preferences and a first associated computing device, the system comprising:
a system server;
a database for storing the message forwarding preferences; and
application software running on the system server operable to perform the steps of:
receiving an electronic buy offer from the buyer,
receiving an electronic sell offer from the seller,
comparing the buy and sell offers to obtain a match result,
accessing the message forwarding preferences of at least one of the buyer and seller from the database,
detecting an online status of the first associated computing device of the at least one of the buyer and seller,
comparing the detected online status with the message forwarding preferences of the at least one of the buyer and seller to obtain a comparison result, and
communicating the match result to the at least one of the buyer and seller through communication media determined by the comparison result.

18. The system of claim 17, the communicating step comprising:
sending an email message to the first computing device of the at least one of the buyer and seller if the detected online status indicates the first computing device is online, the email message identifying the match result.

19. The system of claim 17, the communicating step comprising:
sending a text message to a second computing device of the at least one of the buyer and seller if the detected online status indicates the first computing device is offline, the text message identifying the match result.

20. The system of claim 19, the first computing device is an email computing device, the second computing device is a mobile computing device.

21. The system of claim 20, the mobile computing device is a mobile phone.

22. The system of claim 20, the email computing device is a personal computer.

23. The system of claim 17, the message forwarding preferences comprising information selected from the group consisting of:
a set of users;
a time;
a date; and
a user login status.

24. The system of claim 17, the detecting step comprising:
receiving a data packet from the first computing device; and
storing the online status in response to receiving the data packet.
